(19) United States
(12) Patent Application Publication
(10) Pub. No.: US 2024/0329513 A1
(43) Pub. Date: Oct. 3, 2024

(54) CAMERA AND METHOD OF ASSEMBLING

(71) Applicant: Motherson Innovations Company Ltd, London (GB)

(72) Inventor: Romel Davila, London (GB)

(21) Appl. No.: 18/618,727

(22) Filed: Mar. 27, 2024

(30) Foreign Application Priority Data
Mar. 30, 2023 (DE) 102023108216.7

(51) Int. Cl. G03B 30/00

(52) U.S. Cl. CPC G03B 30/00

(57) ABSTRACT

The subject matter described herein includes a camera, in particular for a rear view device, for use with road vehicles. The camera includes a housing having an aperture. The camera further includes a circuit board configured to be coupled to the housing. The camera further includes a connector configured to be contacted to the circuit board. The camera further includes a connector housing configured to be coupled to the housing. The connector is configured to protrude through the aperture and be coupled to the connector housing. The subject matter described herein also includes a method of assembling a camera.

### PRIORITY CLAIM

This application claims the priority benefit of German Patent Application Number 102023108216.7, filed Mar. 30, 2023, the disclosure of which is incorporated herein by reference in its entirety.

### FIELD OF THE INVENTION

The present invention relates to a camera for use with road vehicles. Furthermore, the present invention relates to a method of assembling such a camera.

### BACKGROUND OF THE INVENTION

Rear view assemblies for road vehicles can comprise a variety of different components dedicated to enabling the user to obtain a rear facing view to the rear side of the vehicle that is being operated. In order to provide a view of said rearward facing side, different types of technologies have been implemented ranging from mirror-based solutions to camera-based solutions, which are also known as camera monitoring systems (CMS).

These camera-based solutions make use of at least one camera, which captures the rear and/or surrounding environment in order to provide the captured images to the operator of the vehicle through a monitor or the like. The camera-based solutions often comprise an image sensor, also known as an imager, which is placed or housed on a circuit board, which in turn is aligned with an optical axis of a lens or lens-package. This alignment of the optical axis of the lens and the imager is crucial with regard to sharpness, quality and/or usability of the collected image of the imager, which is provided to the user. In this way, camera-based solutions and as such their assemblies for use with road vehicles have to be constructed and designed in order to allow this crucial alignment to be carried out.

For example, U.S. Pat. No. 11,267,408 B2 describes a vehicular camera assembly including a rear housing portion with an integral rear attachment portion comprising a conductive element, which is configured to electrically receive an electrical connector and allow for the required alignment.

### SUMMARY OF THE INVENTION

In view of the above, there is a need to provide an improved camera for use with road vehicles allowing for increased design flexibility and cost-reduction, and a corresponding improved method of assembling a camera.

In accordance with aspects of this disclosure, a camera as recited in claim 1 and a method of assembling a camera as recited in claim 14 are provided.

According to one aspect, the present invention provides a camera, in particular for a rear view device, for use with road vehicles. The camera comprises a housing comprising an aperture; a circuit board configured to be coupled to the housing; a connector configured to be contacted to the circuit board; and a connector housing configured to be coupled to the housing. The connector is configured to protrude through the aperture and be coupled to the connector housing.

According to another aspect, the invention provides a method of assembling a camera comprising the following steps: providing a housing, a circuit board, a connector and a connector housing, wherein the housing comprises an aperture; contacting the connector to the circuit board; coupling the circuit board to the housing; arranging the circuit board such that the connector protrudes through the aperture; and coupling the connector housing to the connector.

The underlying discovery on which the present invention is based that there is no necessity to provide an intermediate component arranged within the housing of the assembly in order to compensate for the final position of the connector due to image sensor and lens alignment.

The idea on which the present invention is based is therefore to provide an aperture in the housing through which the connector can protrude in order to be joined with a connector housing in the final position of said connector after the image sensor and lens have been aligned.

Advantageously, there is no necessity to provide an intermediate component, which is configured to physically and/or electrically receive the connector within the housing in order to compensate for the final position of said connector due to the alignment of the image sensor and lens. In this way, it is possible to manufacture the housing with less design restrictions, which can effectively reduce manufacturing costs and duration. Furthermore, the housing itself and the assembly overall comprises a lower amount of individual parts, which in turn results in higher cost effectiveness and less total manufacturing or assembling steps. Additionally, since the housing does not comprise any additional intermediate components, less care has to be taken in handling the housing during said assembly, which can result in reducing assembly set-up times and/or assembly preparation times. In this way, the transportation costs can also be reduced, since less dampening has to be provided due to there being no intermediate and possibly fragile electrical and/or physical components within the housing.

The housing can be configured as a camera housing, wherein the housing is configured to house all components necessary for operating a camera. In this way, the housing can provide physical protection, strength, stability and/or sealing properties with respect to the enclosed components. In particular, the housing can provide a seal rated at a minimum of IP67 and up to IP69. Furthermore, the housing can comprise internal attachment points and/or attachments sections for receiving the enclosed components.

Additionally, the rear view device can be configured for use within a camera monitoring system. Furthermore, the rear view device can be configured to provide a rear facing view of a vehicle. In particular, the rear view device can be configured as a rear view mirror, wherein a mirror is used in combination with a camera in order to provide a rear facing view of a vehicle.

Furthermore, the housing comprises an aperture. In particular, the aperture can be configured as any type of opening in the surface of the housing, which provides a passage from the outside surrounding environment of the housing to the inside of the housing and vice-versa. Furthermore, the aperture can be manufactured simultaneously with the manufacturing of the housing itself, in particular formed or molded integral with the housing, or can be machined into the housing at a later stage, by means of drilling and/or cutting.

In particular, the circuit board can be configured as a printed circuit board (PCB), which provides an electrical connection interface for the camera. In this way, a central electrical component is provided that enables communication between the individual components within the camera. The connector can be configured as an electrical connector, which is electrically contacted to the circuit board in order to send and receive signals, in particular send and receive signals related to the operation of a camera.

Furthermore, the connector can be configured to fully protrude through the aperture comprised in the housing. In particular, the connector can be configured to enter the aperture at a first side of the housing and exit the aperture at a second side of the housing. The first and second side of the housing can be on opposite sides of the housing, wherein one side of the housing in an inner side and the other side of the housing is an outer side of the housing. Furthermore, the connector can be configured to fully pass through the aperture of the housing, wherein a section of the connector physically extend past the outer boundary of the housing. The connector can be configured to comprise a protruding section, wherein the protruding section protrudes a predefined distance through the aperture. The predefined distance can be between 5 and 15 mm, in particular 7.5 to 12.5 mm.

The coupling of the connector and the connector housing can be configured in a form fitting manner, in particular through a tight fit, form fit and/or press fit in order to ensure a physically stable connection. In particular, the connector housing can be formed to comprise a base portion configured to provide a large surface area for coupling with the housing. In particular, the housing can be formed to comprise an attachment section configured to provide a large surface area to receive the connector housing, in particular the base portion of the connector housing.

Advantageously, the method of assembling a camera comprises an additional step of aligning an image sensor arranged on a first side of the circuit board with a lens, wherein the optical axis of the lens is aligned with the corresponding axis of the image sensor. In particular, the alignment is carried out in order to ensure the camera can capture an adequately sharp and focused image. Furthermore, the step of contacting the connector to the circuit board involves soldering the connector to the circuit board in order to establish an electrical connection.

Advantageous or preferred features of the invention are recited in the dependent claims.

In a preferred embodiment, the housing comprises a front housing section and a back housing section, wherein the circuit board is configured to be coupled to the front housing section and the connector housing is configured to be coupled to the back housing section. In this way, the housing is separated into two individual sections, which enables easier assembly due to improved access to the internal surfaces, in particular the internal connection areas, of the respective front housing section and back housing section. The front housing section and back housing section can be configured as two similarly sized sections or one of the sections can be configured as significantly larger than the other section. In particular, the larger of the two sections can be configured as the designated section that receives all or the bulk of the internal components, while the smaller section can be configured as a cover and/or lid, which is compatible to the larger section. In particular, the front housing section and back housing section are configured to be coupled in order to form the housing. Furthermore, the front housing section and back housing section can be coupled by means of suitable mechanical connection elements or by means of a material connection. In particular, the back housing section can comprise the aperture.

In a preferred embodiment, the connector is configured to not contact the back housing section. In this way, there is no necessity to receive the connector within the back housing section, which results in a less complex back housing section with increased design freedom. In particular, the connector can be configured to not electrically contact the back housing section. In this way, there is no necessity to provide an intermediate electrical component within the back housing. Furthermore, the connector can be configured to not directly contact the back housing section, wherein the connector is not physically abutting the back housing section. In particular, the connector can be configured to not contact the housing.

In a preferred embodiment, the connector housing is configured as a floating component, in particular configured to be spatially adjustable. In this way, the connector housing is configured to be able to be coupled to the housing, in particular the back housing section, in different positions, depending on the final position of the connector. In particular, the spatial adjustability of the connector housing with respect to the housing, in particular the back housing section, can be between 10 and 40 micrometers, in particular 20 and 30 micrometers. In this way, it is possible to perform the alignment of the image sensor and lens, which influences the position of the connector, and still be able to couple connector housing to the housing or the back housing section without any risk of incompatibility.

In a preferred embodiment, the back housing section comprises an outward facing surface, and the connector housing is configured to be coupled to the surface. In this way, the back housing section comprises an optimal attachment section configured adequately receive the connector housing in order ensure stability of the connector. The outward facing surface can be configured as a sufficiently flat surface, in particular an optimally machined surface in order to facilitate the coupling of the connector housing. Alternatively, the outward facing surface can be configured as having a complementary surface pattern to the connector housing, in particular an underside of the connector housing, in order to provide an optimal fit and/or facilitate the coupling process. Furthermore, the underside of the connector housing can be formed as a base portion of the connector housing. In particular, the outward facing surface can be configured as a surface facing away from the internals of the camera. Furthermore, the outward facing surface of the back housing section can be configured to provide a large surface area to receive the connector housing, in particular the base portion of the connector housing.

In a preferred embodiment, the back housing section and/or connector housing are manufactured of a non-metallic material, in particular plastic. In this way, the back housing section and/or connector housing are manufactured of inexpensive, light-weight and design friendly materials, which also allows for overall cost reduction of the camera. Furthermore, the use of non-metallic materials reduces the risk of rusting due to moisture ingress or material deterioration due to other environmental effects.

Furthermore, the back housing section and/or connector housing can comprise form-coding features. In this way, the assembly process of the camera is improved through the complete avoidance of any incorrect assemblies during the assembly process.

In a preferred embodiment, the circuit board comprises a first side, wherein the first side is arranged and configured to be facing towards the front housing section, and wherein a lens is configured to be coupled to the front housing section, and wherein an image sensor is configured to be arranged on the first side. In this way, the circuit board is able to receive the individual components in order for the correct function of the camera. In particular, the lens can be configured as a lens arrangement that comprises multiple lenses. Furthermore, the image sensor can be a digital image sensor, in particular an active-pixel sensor or CMOS sensor.

In a preferred embodiment, the circuit board comprises a second side, wherein the second side is configured to be facing towards the back housing section and the connector is configured to be soldered to the second side. In this way, the circuit board is provided as the central electrical component that receives the image sensor on the first side the connector on the second side. Furthermore and due to the first and second side of the circuit board, the alignment of the image sensor and the lens translates to the final position of the connector on the second side of the circuit board. In particular, the image sensor and connector can be configured to be soldered to the first side. Furthermore, the connector and image sensor can be configured to be arranged on the same side of the circuit board. In this way, the camera may be utilized for special applications, wherein it is required that the image sensor and connector are arranged on the same side of the circuit board.

In a preferred embodiment, the connecter is configured as a FAKRA connector. In this way, the connector is optimally configured for use with road vehicles and similar applications. In particular, the connector can satisfy the requirements under DIN 72594-1 und USCAR-18. Furthermore, the connector can comprise color-coding as well as mechanical coding in order to improve assembly and/or avoid incorrect connections.

In a preferred embodiment, the connector housing is coupled to the housing using a material connection, in particular a laser weld. In this way, a strong, sturdy and long-lasting material connection is provided. Furthermore, a laser weld is preferred due to the minimal thermal impact on the surrounding components and the minimal post-welding processing costs. Alternatively, the material connection can be configured as a solvent weld, friction weld, hot gas weld, and/or infrared weld. In particular, the connector housing can be coupled to the back housing section using a material connection, in particular a laser weld.

In a preferred embodiment, the connector housing is manufactured of an at least partially optically transparent material. In this way, it is possible to avoid melting the outer surface of the connector housing, while utilizing a laser to melt the underlying housing, in particular back housing section. In particular, the material is at least partially optically transparent for a wavelength of an applied laser. In this way, it is possible to couple the connector housing and housing, in particular back housing section, according to an indirect laser melting method.

In an embodiment of the method, the housing comprises a front housing section and a back housing section. The method further comprises the steps of arranging the circuit board on the front housing section, and arranging the connector housing on the back housing section. In particular, the back housing section comprises an outward facing surface and the method comprises the step of arranging the connector housing on the outward facing surface. In this way, the housing is separated into two distinct sections, wherein each section provides a specific function for the assembly of the camera.

In a preferred embodiment of the method, the step of coupling the connector housing to the housing comprises providing a material connection, in particular according to a laser welding process. In this way, a strong, sturdy and long-lasting connection is provided, which can be integrated into an automated assembly process. In particular, the material connection is provided for coupling the connector housing to the back housing section.

In a preferred embodiment of the method, the step of providing a material connection comprises the following steps: melting the connector housing by heating and melting the housing by a laser by means of heat conduction, wherein the housing absorbs energy from the laser; and applying pressure to the connector housing and/or the housing. In particular, the connector housing is an at least partially optically transparent material, wherein the method comprises the step of directing the laser through the connector housing and onto the surface of the housing, in particular the back housing section. In this way, the material of the housing or back housing section where the laser is incident is melted. In particular, the melted material of the housing or back housing section transfers heat through heat conduction to the connector housing and melts the connector housing forming a mutual melting pool, which forms a high quality material connection. In particular, the step of applying pressure pressing the connector housing and/or housing against each other during the duration of the melting step. Furthermore, the step of applying pressure can press the connector housing and/or the back housing section against each other.

In a preferred embodiment of the method, the step of contacting further comprises contacting an image sensor to the circuit board. Furthermore, the step of contacting an image sensor and the connector to the circuit board can comprise a step of soldering the connector to the circuit board during the surface mount technology (SMT) process, wherein the image sensor is soldered into and/or to the circuit board.

In a preferred embodiment of the method, the step of coupling further comprises coupling a lens to the housing. In particular, the lens can be coupled to the housing using mechanical connections means and/or an adhesive solution. Additionally, the step of coupling the lens to the housing can comprise a step of aligning, in particular actively aligning, the image sensor and lens, in particular wherein axis of the lens is aligned with the the optical corresponding axis of the image sensor.

The above embodiments can be combined with each other as desired, if useful. Further possible embodiments, further configurations and implementations of the invention also include combinations, not explicitly mentioned, of features of the invention described herein with respect to the embodiments. In particular, the skilled person will thereby also add individual aspects as improvements or additions to the respective basic form of the present invention.

### BRIEF DESCRIPTION OF THE DRAWINGS

For a more comprehensive understanding of the invention and the advantages thereof, exemplary embodiments of the invention are explained in more detail in the following description with reference to the accompanying drawing figures, in which like reference characters designate like parts and in which:

FIG. 1 shows a schematic representation of a camera; and

FIG. 2 shows a schematic representation of a camera according to an embodiment; and

FIG. 3 shows a connector housing and back housing section; and

FIG. 4 shows a sectional view A-A of the embodiment shown in FIG. 3; and

FIG. 5 shows an exploded view of the embodiment shown in FIG. 3; and

FIGS. 6A-6D show stages of the coupling of the connector housing and the housing; and

FIG. 7 shows a flow chart of a method of assembling a camera.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the resulting advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of inquiry and study, except where specific meanings have otherwise been set forth herein.

### DETAILED DESCRIPTION OF EMBODIMENTS

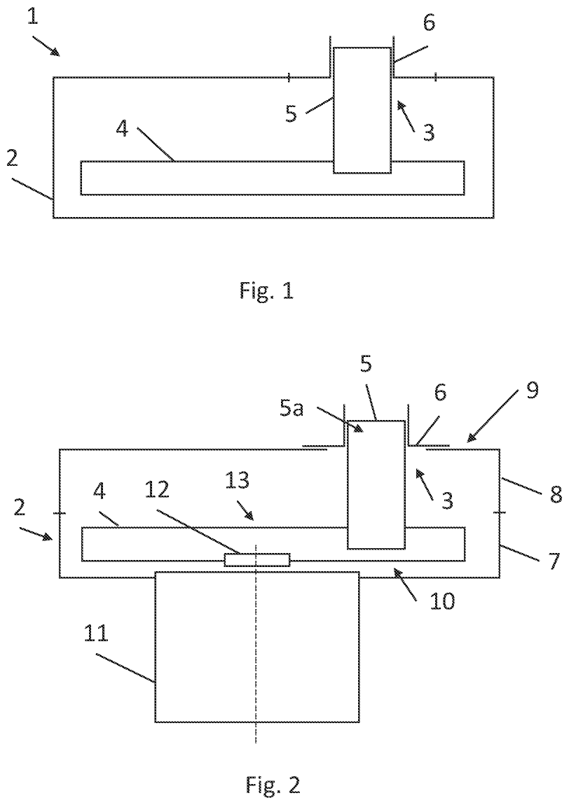

FIG. 1 shows a schematic representation of a camera 1. The shown schematic representation depicts a strongly simplified version of the camera 1.

In the shown representation, the camera 1 is configured for use with road vehicles. In particular, the camera 1 may be configured for a rear view device.

The camera 1 comprises a housing 2 comprising an aperture 3, a circuit board 4 configured to be coupled to the housing 2, a connector 5 configured to be contacted to the circuit board 4, and a connector housing 6 configured to be coupled to the housing 2. The connector 5 is configured to protrude through the aperture 3 and be coupled to the connector housing 6. The shown schematic representation depicts the connector 5 extending past the aperture 3 but not extending past the connector housing 6. Alternatively, the connector 5 may extend past both the connector housing 6 and aperture 3.

Furthermore, the connector 5 is configured to not contact the housing 2. In the shown embodiment, the housing 2 is depicted with a rectangular shape. The shape of the housing 2 can be configured freely in order to satisfy structural and/or design requirements.

FIG. 2 schematic representation of a camera 10 according to an embodiment.

In this embodiment, the housing 2 comprises a front housing section 7 and a back housing section 8. The respective front housing section 7 and back housing section 8 are shown as similarly sized rectangles, which are joined along one of their respective longer sides. Furthermore, the circuit board 4 is configured to be coupled to the front housing section 7. The coupling of the circuit board 4 to the front housing section 7 is shown through the placement of the circuit board 4 within the boundaries of the front housing section 7. Additionally, the connector housing 6 is configured to be coupled to the back housing section 8. Additionally, the aperture 3 is shown as comprised in the back housing section 8. Furthermore, the protruding section 5a is shown as the section of the connector 5 that protrudes through the aperture 3. Additionally, the connector housing 6 is shown to have a two L-shaped cross sections on either side of the protruding section 5a of the connector 5.

As shown, the circuit board 4 comprises a first side 10, which is arranged and configured to be facing towards the front housing section 7. Furthermore, a lens 11 is configured to be coupled to the front housing section 7, and an image sensor 12 is configured to be arranged on the first side 10. The crucial alignment of the optical axis of the lens 11 and the image sensor 12 is shown with the dotted line.

Additionally, the circuit board 4 comprises a second side 13, which is configured to be facing towards the back housing section 8. As shown, the connector 5 is configured to be soldered to the second side 13 of the circuit board 4. The positioning of the image sensor 12 and connector 5 on the first side 10 and second side 13 of the circuit board 4 is purely exemplary. Moreover, the back housing section 8 comprises an outward facing surface 9 and the connector housing 6 is configured to be coupled to the surface outward facing 9. Furthermore, the connecter 5 is configured as a FAKRA connector.

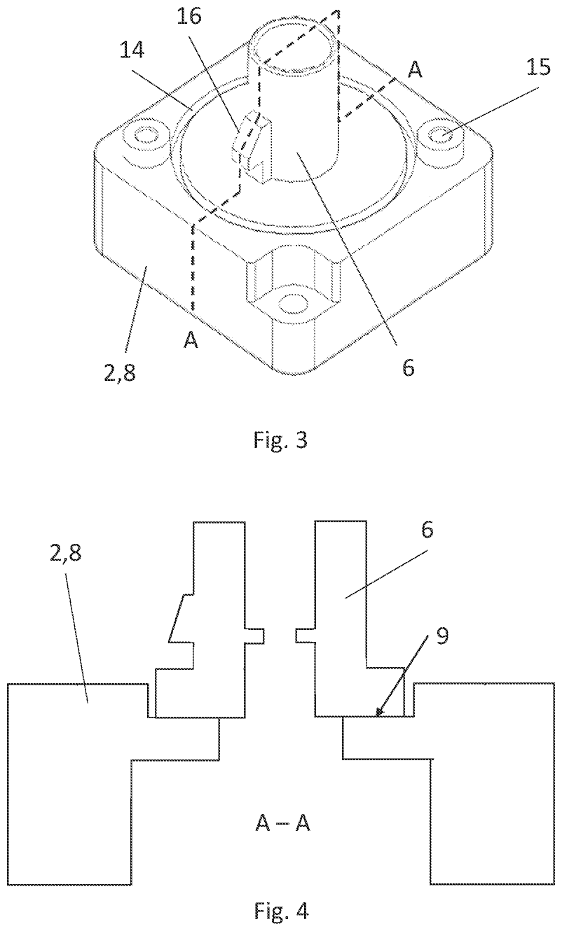

FIG. 3 shows a connector housing 6 and back housing section 8.

In this embodiment, the back housing section 8 is shown as a square shaped component with rounded corners and an interface 14 with a essentially circular shape configured to receive the connector housing 6. The central location and the circular shape of the interface 14 is merely exemplary. As shown, the back housing section 8 comprises connection elements 15 at each of its four corners configured to couple the back housing section 8 with the front housing section 7 in order to form the housing 2.

The shown connection elements 15 can also be configured as knobs, rivets, clips, bolts, screws, clamps, slots and/or angles according to design or functional requirements. Additionally, a latch 16 is shown on the connector housing 6 configured to fixate an attached cable or the like to the connector housing 6.

Furthermore, a dotted line A-A is shown which indicates the cutting plane of the sectional view of FIG. 4.

FIG. 4 shows a sectional view A-A of the embodiment shown in FIG. 3.

As shown, the connector housing 6 is coupled to the back housing section 8 at an outward facing surface 9. The back housing section 8 and/or are connector housing 6 manufactured of a non-metallic material. In particular, the back housing section 8 and/or connector housing 6 can be manufactured of plastic. The size of the overlapping area of the outward facing surface 9 between the connector housing 6 and back housing section 8 can be dimensioned in accordance with design and or functional requirements. Furthermore, a larger overlapping area of the outward facing surface 9 can aid in providing a strong and stable connection between the connector housing 6 and back housing section 8.

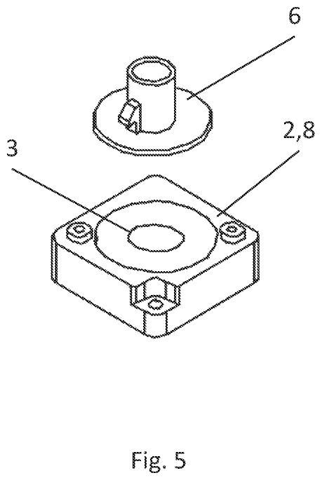

FIG. 5 shows an exploded view of the embodiment shown in FIG. 3.

As shown, the connector housing 6 and back housing section 8 are exemplarily separated. Additionally, back housing section 8 comprises the aperture 3 through which the connector 5 (not shown) protrudes. The connector housing 6 is configured as a floating component. The connector housing 6 is coupled to the back housing section 8 after the connector 5 (not shown) reaches its final position dependent on the alignment of the lens and image sensor. In particular, the connector housing 6 is configured to be spatially adjustable in order to compensate for said final position of the connector 5 (not shown).

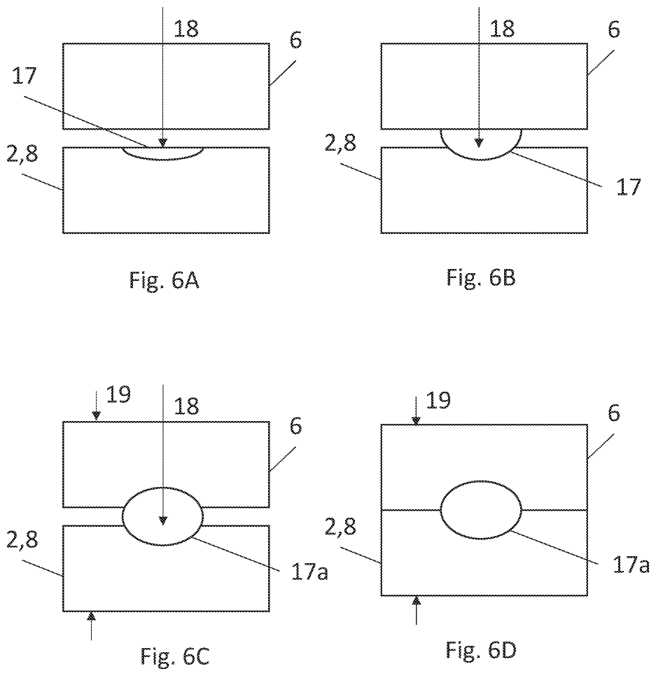

FIGS. 6A-6D show stages of the coupling process of the connector housing 6 and the back housing section 8.

As shown, the respective figures A-D contain schematic representations of the connector housing 6 and the back housing section 8, which are respectively shown as rectangles arranged parallel to each other. The alphabetical order A-D of the respective figures indicates the stages of the coupling process in a chronological order, wherein the connector housing 6 is coupled to the housing 2 using a material connection, in particular a laser weld. The following description of the coupling process references the connector housing 6 and the back housing section 8. Nevertheless, the same also applies to the connector housing 6 in combination housing 2.

FIG. 6A shows a laser 18 incident on the surface of the back housing section 8, which creates a melt pool 17 of the material of the back housing section 8. The connector housing 6 is manufactured of an at least partially optically transparent material, in particular transparent for a wavelength of the applied laser 18. In this way, the laser 18 passes through the connector housing 6 without heating and/or melting the connector housing 6.

FIG. 6B shows a propagation of the melting pool 17 of the back housing section 8, wherein the melting pool 17 has increased in size and is effectively abutting the connector housing 6. The connector housing 6 is melted by means of heat conduction from the melting pool 17 of the back housing section 8.

FIG. 6C shows the addition of pressure 19 to the connector housing 6 and/or the back housing section 8 in order to press the individual components together. Additionally, a mutual melting pool 17a is shown, wherein the melted material of the connector housing 6 and the back housing section 8 are mixed. The mutual melting pool 17a forms a high quality material connection.

FIG. 6D shows the last stage of the coupling process, wherein the connector housing 6 and the back housing section 8 are abutting due to the pressure 19 and the mutual melting pool 17a begins to cool ensuring a strong material connection.

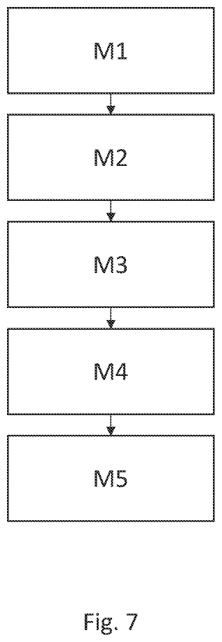

FIG. 7 shows a flow chart of a method of assembling a camera 10.

The shown method of assembling comprises five method steps M1-M5. The numbering of the method steps M1-M5 only serves as a means to differentiate the different method steps M1-M5 from each other and does not imply an order in which the method steps M1-M5 have to be carried out. The order of the method steps M1-M5 can be carried out in a different order than is shown in FIG. 7.

The method of assembling a camera 1 comprises the step of providing M1 a housing 2, a circuit board 4, a connector 5 and a connector housing 6, wherein the housing 2 comprises an aperture 3. The method furthermore comprises the step of contacting M2 the connector 5 to the circuit board 4.

The method also comprises the steps of coupling M3 the circuit board 4 to the housing 2 and arranging M4 the circuit board 4 that the connector 5 protrudes through the aperture 3. Additionally, the method comprises the step of coupling M5 the connector housing 6 to the connector 5.

Furthermore, the housing 2 comprises a front housing section 7 and a back housing section 8, and the method further comprises the steps of arranging the circuit board 4 on the front housing section 7 and arranging the connector housing 6 on the back housing section 8.

In an embodiment, the previously described step of coupling the connector housing 6 to the connector 5 comprises providing a material connection, in particular according to a laser welding process.

Additionally, the step of providing a material connection comprises the steps of melting the connector housing 6 by heating and melting the housing 2 by a laser 18 by means of heat conduction, wherein the housing 2 absorbs energy from the laser 18 and applying pressure 19 to the connector housing 6 and/or the housing 2.

Furthermore, the step of contacting M2 further comprises contacting an image sensor 12 to the circuit board 4. In particular, the image sensor 12 can be soldered to the circuit board 4. Additionally, the step of coupling M3 further comprises coupling a lens 11 to the housing 2. Furthermore, the lens 11 can be aligned, in particular actively aligned, with the image sensor 12 on the circuit board 4.

Although specific embodiments illustrated and described herein, it will be appreciated by of the invention are those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF REFERENCE SIGNS

1 camera
2 housing
3 aperture
4 circuit board
5 connector
5a protruding section
6 connector housing
7 front housing section
8 back housing section
9 surface
10 first side
11 lens
12 image sensor
13 second side
14 interface
15 connection element
16 latch
17 melting pool
17a mutual melting pool
18 laser
19 pressure
M1-M5 Method steps

What we claim is:

1. A camera for use with road vehicles, the camera comprising:
a housing comprising an aperture;
a circuit board configured to be coupled to the housing;
a connector configured to be contacted to the circuit board;
a connector housing configured to be coupled to the housing wherein the connector is further configured to protrude through the aperture and be coupled to the connector housing.

2. The camera of claim 1, wherein the housing comprises a front housing section and a back housing section,
wherein the circuit board is configured to be coupled to the front housing section, and
wherein the connector housing is configured to be coupled to the back housing section.

3. The camera of claim 2, wherein the connector is configured to not contact the back housing section.

4. The camera of claim 1, wherein the connector housing is configured as a floating component or wherein the connector housing is configured to be spatially adjustable.

5. The camera of claim 2, wherein the back housing section comprises an outward facing surface, wherein the connector housing is configured to be coupled to the surface.

6. The camera of claim 2, wherein at least one of the back housing section and connector housing is manufactured of a non-metallic material.

7. The camera of claim 2, wherein the circuit board comprises a first side,
wherein the first side is arranged and configured to be facing towards the front housing section; and
wherein a lens is configured to be coupled to the front housing section, and wherein an image sensor is configured to be arranged on the first side.

8. The camera of claim 2, wherein the circuit board comprises a second side;
wherein the second side is configured to be facing towards the back housing section; and
wherein the connector is configured to be soldered to the second side.

9. The camera of claim 1, wherein the connecter is configured as a FAKRA connector.

10. The camera of claim 1, wherein the connector housing is coupled to the housing using a material connection or a laser weld.

11. The camera of claim 10, wherein the connector housing (6) is manufactured of an at least partially optically transparent material.

12. The camera of claim 11, wherein the at least partially optically transparent material is transparent for a wavelength of an applied laser.

13. The camera of claim 1, wherein the camera is a camera for a rear view device.

14. A method of assembling a camera, the method comprising:
Providing a housing, a circuit board, a connector and a connector housing, wherein the housing comprises an aperture;
Contacting the connector to the circuit board;
Coupling the circuit board to the housing;
Arranging the circuit board such that the connector protrudes through the aperture; and
Coupling the connector housing to the connector.

15. The method of claim 14, wherein the housing comprises a front housing section and a back housing section, wherein the method further comprises:
arranging the circuit board on the front housing section, and
arranging the connector housing on the back housing section.

16. The method of claim 14, wherein the step of coupling the connector housing to the housing comprises providing a material connection.

17. The method of claim 16, wherein the step of providing a material connection comprises the following steps:
Melting the connector housing by heating and melting the housing by a laser by means of heat conduction, wherein the housing absorbs energy from the laser;
Applying pressure to the connector housing or the housing.

18. The method of claim 14, wherein the step of contacting further comprises contacting an image sensor to the circuit board.

19. The method of claim 14, wherein the step of coupling further comprises coupling a lens to the housing.

20. The method of claim 14,
wherein the housing comprises an aperture;
wherein the circuit board is configured to be coupled to the housing;
wherein the connector is configured to be contacted to the circuit board;
wherein the connector housing is configured to be coupled to the housing wherein the connector is further configured to protrude through the aperture and be coupled to the connector housing.
